(19) United States
(12) Patent Application Publication
(10) Pub. No.: US 2023/0355461 A1
(43) Pub. Date: Nov. 9, 2023

(54) COMPRESSIVE HEATING SYSTEM WITH ACTIVE FEEDBACK CONTROL FOR MEDICAL APPLICATION

(71) Applicant: Rochester Regional Health, Rochester, NY (US)

(72) Inventors: Lauren Rose Smith, Lancaster, NY (US); Madison Latour, Rochester, NY (US); Raymond D. Naraine, Queens, NY (US); Peter Stluka, Reston, VA (US); Oliver Lindblom, Irondequoit, NY (US); Nicholaus Monsma, Rochester, NY (US)

(73) Assignee: Rochester Regional Health, Rochester, NY (US)

(21) Appl. No.: 18/137,667

(22) Filed: Apr. 21, 2023

Related U.S. Application Data
(60) Provisional application No. 63/333,739, filed on Apr. 22, 2022.

(51) Int. Cl. A61H 9/00

(52) U.S. Cl. CPC A61H 9/0078; A61H 2201/0207; A61H 2201/5002; A61H 2201/5071; A61H 2201/5082

(57) ABSTRACT

A system for thermal compression therapy comprises at least one thermal compression device including one or more compression bladders, the one of more compression bladders configured to be selectively expandable in response to introduction of fluids therein and a thermal conductive member disposed about the one or more compression bladders. The thermal conductive member includes a thermal conductive layer configured to distribute heat uniformly across an area of the limb of the patient.

### CROSS-REFERENCE TO RELATED APPLICATION

This application claims priority to and the benefit of U.S. patent application Ser. No. 63/333,739, entitled “Medical Finger and Toe Warmer,” filed Apr. 22, 2022, which is incorporated herein by reference in its entirety.

### BACKGROUND

The present invention is directed to a system, apparatus and methodology for compressing one or more extremities of a subject to enhance circulation in the extremities, and, more particularly, relates to a system including one or more thermally activated compressive devices with a feedback control system adapted to maintain and coordinate active pressure and temperature control to maximize circulation of a non-ambulatory subject.

Patients suffering from Symmetrical Peripheral Gangrene (SPD) frequently lose circulation to their extremities as the disease progresses. This lack of circulation can lead to tissue death, and often the loss of one or more fingers and toes. It has been observed that increasing the skin temperature, as well as sequential compression of the extremities, can result in improved blood flow and reduction of damaged tissue.

There are many situations in which patients in an intensive care unit (ICU) have dangerously low blood pressure. These patients are treated with medications called vasopressors, which constrict blood vessels to increase blood pressure. A common side-effect of these medications is a dangerous decrease in blood flow to the extremities, which often results in tissue death and partial or complete loss fingers and toes. Since the extremities are a lower priority than the patient's life, this is often considered an acceptable loss. An increase in temperature to these areas can promote blood flow and reduce the likelihood of damage to the affected areas. There are hand and toe warmers and gloves on the market that warm up tissue which increases blood flow. These medical and non-medical products allow patients to counter the side effect of less blood reaching the fingers and toes and thus causing those appendages to expire. Such devices already exist, however the designs are not optimized for this purpose. Current products may not allow for easy removal and usage, and often do not have safety features to prevent the device from causing more harm to the patient instead of helping them.

### SUMMARY

Accordingly, the present invention is directed to a system, methodology and device that mimics the outcome of hand warmers and gloves, regulates temperatures within predetermined values and facilitates data collection of the patient's body parts and/or functioning of the equipment. The device is readily deployable onto the subject and may be removed without irritation, harm etc. to the subject or who, in certain circumstances may not be able to communicate or identify any irritating or uncomfortable characteristics of the device.

In one illustrative embodiment, a system for thermal compression therapy comprises at least one thermal compression device for arranging relative to a limb of a patient, including: one or more compression bladders configured to be selectively expandable in response to introduction of fluids therein; and a thermal conductive member disposed about the one or more compression bladders, the thermal conductive member including a thermal conductive layer configured to distribute heat uniformly across an area of the limb of the patient.

In certain embodiments, the thermal conductive layer comprises a conductive carbon layer. In other embodiments, the system includes one or more pressure sensors and one or more temperature sensors.

In embodiments, a controller is in communication with the one or more pressure sensors and the one or more temperature sensors. In illustrative embodiments, the controller is configured to control flow of fluids into the one or more compression bladders in response to signals received from the one or more pressure sensors and is configured to control temperature of the thermal conductive member in response to signals received from the one or more temperature sensors.

The system may include a plurality of thermal compression devices configured for arrangement around respective extremities of the patient. The controller may be configured to control operation of multiple thermal compression devices

### BRIEF DESCRIPTION OF THE DRAWINGS

Various aspects and features of the present disclosure are described hereinbelow with references to the drawings, wherein:

FIG. 1 is a view illustrating the system and methodology for compressing one or more extremities of a subject to enhance circulation in the extremities in accordance with one or more exemplative embodiments of the present disclosure;

FIG. 2 is a view of one illustrative embodiment of a thermal compression device of the system and methodology of FIG. 1 in accordance with one or more exemplative embodiments of the present disclosure;

FIG. 3 is a separated view of a single compression component of the thermal compression device of FIGS. 1 and 2 in accordance with one or more exemplative embodiments of the present disclosure;

FIG. 4 is a view of another illustrative embodiment of a thermal compression device of the system and methodology of FIG. 1 in accordance with one or more exemplative embodiments of the present disclosure;

FIG. 5 is a schematic view of the components of the system and methodology of FIGS. 1-4 in accordance with one or more exemplative embodiments of the present disclosure;

FIG. 6 is a view of a controller for use with the system and methodology of FIGS. 1-5 in accordance with one or more exemplative embodiments of the present disclosure;

FIG. 7 is a flow chart illustrating an exemplative use of the system and methodology of FIGS. 1-6 in accordance with one or more exemplative embodiments of the present disclosure;

FIG. 8 is a schematic illustrating some of the electrical components of the system and methodology of FIGS. 1-7 in accordance with one or more exemplative embodiments of the present disclosure;

FIG. 9 is a sample code snippet for testing the functioning of at least some of the components of the system and methodology of FIGS. 1-8 in accordance with one or more exemplative embodiments of the present disclosure; and

FIG. 10 is a graph depicting results of the testing performed in association with the code of FIG. 9 of the system and methodology of FIGS. 1-9 in accordance with one or more illustrative embodiments of the present disclosure.

### DETAILED DESCRIPTION

Particular embodiments of the present disclosure are described hereinbelow with reference to the accompanying drawings. However, it is to be understood that the disclosed embodiments are merely examples of the disclosure and may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to employ the present disclosure in virtually any appropriately detailed structure. In illustrative embodiments, the system is atraumatic results in a substantial reduction in harm and discomfort, increases blood flow in the extremities to which it is applied, and is operable by a single practitioner. In illustrative embodiments, the device of the system has an operational temperature of between about 38° C. to about 41° C., less than 1 minute application time, is able to maintain temperature with 1° C. of the target temperature, and is powered by a standard wall outlet. Other parameters and requirements are also envisioned.

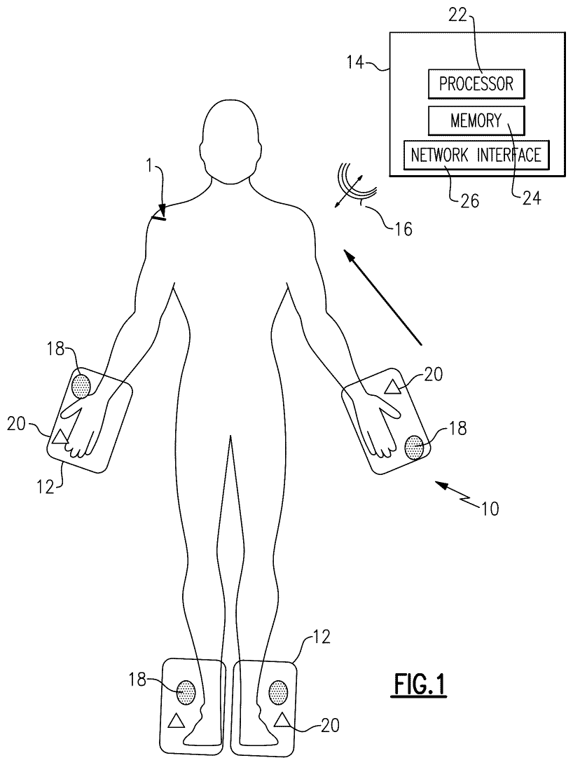

FIG. 1 illustrates the system applied relative to a subject 1. The system 10 includes one or more thermal compression devices 12, a controller 14 for controlling activities of the one or more thermal compression devices 12 and a communication link 16 enabling communication between the one or more thermal compression devices 12 and the controller 14. Four thermal compression devices 12 are shown one for each of the hands and feet of the subject. However, more or less than four thermal compression devices 12 are envisioned. The one or more thermal compression devices 12 include at least one thermal sensor 18 (one is schematically shown) and at least one pressure sensor or transducer 20 (one is schematically shown) built into, mounted to, or otherwise associated with, the respective compression device 12. In embodiments, each thermal compression device may include two or more thermal sensors 18 and two or more pressure sensors 20 to obtain measurements across the area of the thermal compression device 12, for calibration and/or for redundancy to ensure the parameters being detected, i.e., temperature and sensor are accurate. In other illustrative embodiments, the multiple thermal sensors 18 may be disposed within different regions of the compression device 12, for example, one in a heating region adjacent the patient and a second in an insulating region displaced from the patient to avoid trauma to the patient or clinician. In illustrative embodiments, the pressure sensors 20 may be disposed in different locations of the compression device 12, or optionally adjacent multiple bladders in the event the compression device includes two or mor inflatable bladder. The multiple temperature sensors 18 may be of the same sensor type or of different type. Similarly, the multiple pressure sensors 20 may be of the same sensor type or of different type. Any suitable thermal sensor or pressure sensor may be utilized. In one exemplative embodiment, a suitable thermal sensor includes the board mounted TMP36 low voltage, precision centigrade temperature sensor manufactured by Analog Devices. Multiple pressure sensors 20 may include any board mount sensor such as the ABPDANT005PGAA5 Pressure Sensor available from Honeywell.

The communication link, represented schematically as reference numeral 16, may be a wireless communication link configured for radio frequency (RF) or other wireless and/or wired connection with the controller 14. Such RF or other connection may be used to transmit signals to the one or more control modules of the thermal compression devices 12 and receive feedback parameters or other signaling from the thermal sensors 18 and the pressure sensors 20.

The controller 14 includes a processor 22, a memory 24 and a network interface 26. The processor 22 may include one or more individual processing devices such as, for example, a central processing unit (CPU), a microprocessor, a microcontroller, an application-specific integrated circuit (ASIC), a field programmable gate array (FPGA) or other type of processing circuitry, as well as portions or combinations of such circuitry elements. The memory 24 is associated with the processor 22 and includes, for example, random access memory (RAM), read only memory (ROM), a removable memory device, a fixed memory device, and/or a flash memory. The network interface 26 (which can include, for example, modems, routers and Ethernet cards) enables the system to couple to other data processing systems or devices (such as remote displays or other computing and storage devices) through intervening private or public computer networks (wired and/or wireless).

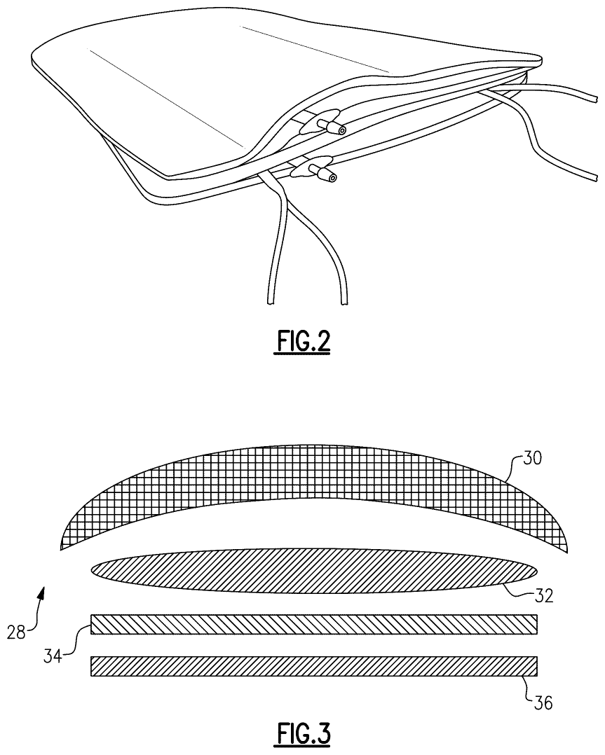

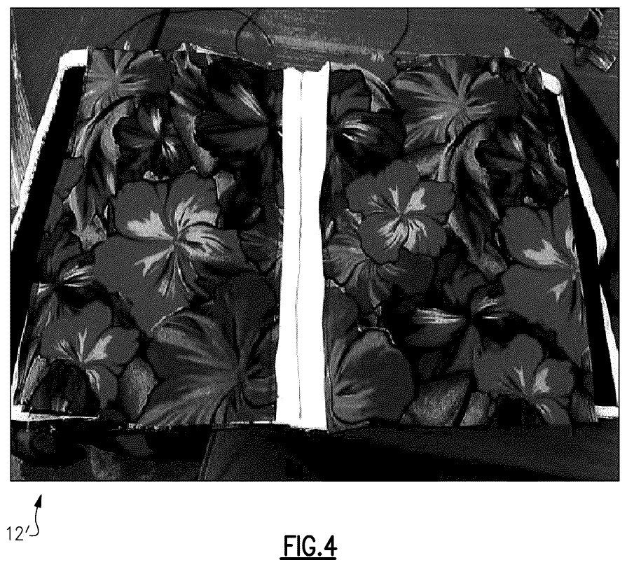

Referring now to FIGS. 2 and 3 one illustrative embodiment of the thermal compression device 12 is illustrated. In this illustrative embodiment of FIG. 2, the thermal compression device 12 is a closed sleeve at least in whole or in part. The thermal compression device 12 includes two components 28 secured to each other along their respective peripheries by conventional methodologies in superposed relation. Fla 3 illustrates, in schematic view, a single component 28. Each component 28 of the thermal compression device 12 includes an outer shell 30, a compression bladder 32 beneath the outer shell 30, a heating component 34 and a protective layer 36. The compression bladder 32 includes an inflatable bag selectively inflatable with a fluid. The fluids may include air or any suitable liquid. In illustrative embodiments, the fluid comprises air. The compression bladder 32 may comprise a vinyl material. The heating component 34 comprises a thermal conductive fabric which is attached to the outer shell 30 through conventional methodologies. The heating component 34 comprises conductive properties which provide even dispersion of thermal energy along the length or area of the thermal fabric. In illustrative embodiments, the heating component 34 is devoid of embedded wires used in commercially available resistive heaters. In other illustrative embodiments, the conductive fabric may include a nonwoven microfiber polyester material. The thermal fabric may be coated with an electric conductive coating which provides smoother and uniform dispersion of thermal energy. In illustrative embodiments, the conductive coating includes at least traces of conductive metals and/or polymers such as without limitation carbon, steel, gold etc. and conductive polymer coatings including polyaniline, polypyrrole or poly-3,4-ethylenedioxthiophene. The protective layer 36 electrically insulates the subject from the heating component 34 and may in illustrative embodiments, provide an additional layer of insulation to reduce heat transferred to the patient. The protective layer 36 may comprise a sheet of polyvinylchloride fabric or the like.

In accordance with the embodiment of FIGS. 2 and 3, a second component substantially, identical to the first component described in connection with FIG. 3 is aligned and secured to the first component to form the thermal compression device 12 of FIG. 2. In other illustrative embodiments, it is envisioned that the thermal compression device 12 may include a single annular or ring shape inflatable compression bladder 32 whereby the compressible bladder 32, heating component 34 and the compressive layer 36 are continuous.

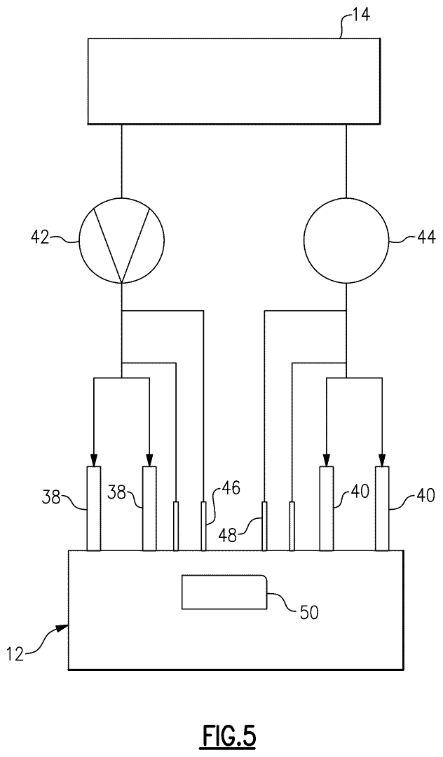

FIG. 4 illustrates another illustrative embodiment of the thermal compression device 12′. The thermal compression device 12′ is substantially similar to the device of FIGS. 2 and 3 but is open, i.e., connected only at one end whereby the thermal compression device 12′ may be wrapped about the arm or foot of the patient. In illustrative embodiments, the extreme outer edges of the thermal compression device 12′ may have fastening means such as VELCRO, hooks or other fastener types to secure the thermal compression device 12′ about the selected body part. In other respects, the thermal compression device 12′ of FIG. 4 is substantially similar or identical to the thermal compression device 12 of FIGS. 2 and 3.

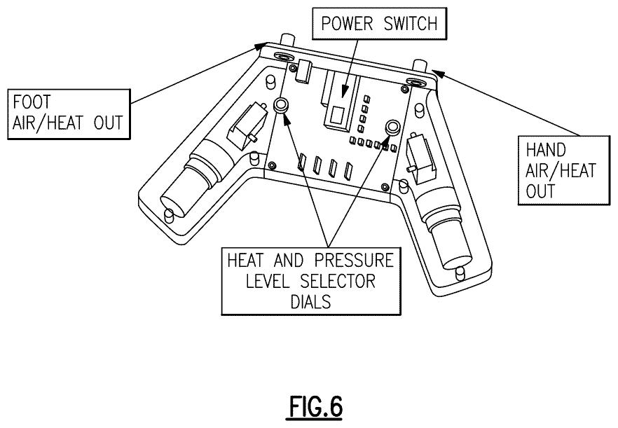

FIG. 5 is a schematic of the components of the system and methodology in accordance with the principles of the present invention. In the schematic, a single thermal compression device 12 is schematically depicted, which would be applied or positioned about the selected limb of the patient. Associated with each thermal compression device 12 is a plurality of ports including a pair of inflation ports 38 with each individual inflation port 38 being in communication, for example, fluid communication, with a respective inflatable bladder 32 of the thermal compression device and a pair of heating ports 40 with each individual heating port being in communication with a respective heating element 34 of the thermal compression device 12. As discussed hereinabove, in other illustrative embodiments, the thermal compression device 12 may include a single annular compressible bladder 34 and a single annular heating element 34 whereby only one inflation port 38 and one heating port 40 may be required. The inflation ports 38 are in communication with an air or fluid pump 42 configured to selectively deliver air or other fluids to inflate the compressible bladders 34 to a desired size based on various parameters. The heating ports 40 are in electrical communication with a heating element 44. The fluid pump 42 and the heating element 44 are controlled either directly or indirectly by the controller 14. In illustrative embodiments, the fluid pump 42 and the heating element 44 may be incorporated into the controller 14. In other illustrative embodiments, the controller 14 is either a part or associated with a control module which houses all the electrical and mechanical parts required to deliver inflation fluids to the compressible bladders 34, regulate temperature, regulate pressure, control the fluid pump 42 and control operation of the various sensors.

With continued reference to FIG. 5, the system further includes a plurality of sensor access ports providing communication or access to one or more of the temperature and pressure sensors 18, 20. In one illustrative embodiment, one or more temperature sensor ports 46 are in communication with respective temperature sensors 18 of the thermal compression device 12 and one or more pressure ports 48 are in fluid communication with the pressure sensors 20 of the thermal compression device 12. The use of the term “port” is not to be restricted to any structural limitation, but rather is to be broadly interpreted to include any means to enable communication, e.g., feedback signals, between the temperature and pressure sensors 18, 20 and the controller 14 either directly or indirectly via the communication link 16.

In illustrative embodiments, the compressible bladder device 12 includes, or is associated with a control module, shown schematically as reference numeral 50, which includes, for example, a processor, memory or logic, wireless capabilities enabling communication between the compression device 12 and the control unit 14 via the communication link 16. More specifically, the control module 50 may enable signals including feedback signals to be delivered between the thermal and pressure sensors 18, 20, and the control unit 14 and the pump device 42 and the heating device 44.

In other illustrative embodiments, each of the thermal compression devices 14 may be individually, selectively or completely controlled by the controller 14. For example, the controller 14 simultaneously may control operation up to four (4) thermal compression device 14, i.e., one on each limb of the patient. In other illustrative embodiments, the controller 14 may control operation of the pump device 42 and the heating elements 44 to control from one (1) to four (4) (including simultaneously) thermal compression devices 14. Moreover, the system may monitor through the thermal sensors 18 and pressure sensors 20 of all of the thermal compression devices 12 and control operation of all thermal compression devices 12 in response to feedback from the respective sensors 18, 20.

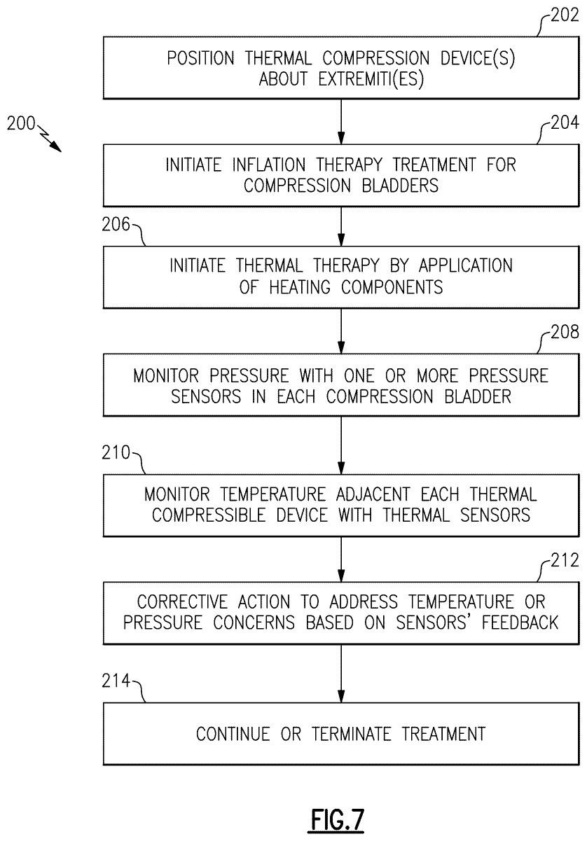

FIG. 6 is a view of a controller 100 for use with the system 10 of the present invention. The controller 100 may be the controller 16 described in connection with FIG. 1, may supplement the controller 16 or otherwise be associated with the controller 16.

FIG. 7 is a flow chart depicting an illustrative methodology of use of the system in compressing, and applying therapy to a patient to improve circulation in one or more extremities of the patient. The methodology 200 includes positioning one or more thermal compression devices about one or more limbs of the patient, (STEP 202). Thereafter, a desired treatment therapy is selected, and the compression bladders 32 of each thermal compression device 12 are inflated to, for example, a predefined pressure as determined by the operator via manipulation of the controller 14 (STEP 204). The desired treatment therapy may include continuous, sequential segmented etc. application of pressure to the extremities. In STEP 206, the desired heating treatment therapy is selected and each of the heating elements may be set to a desired temperature to activate the heating elements within each thermal compression device 12. In STEP 208, the pressure within each compressible bladder 32 is monitored via the pressure sensors or transducers, and feedback is provided to the controller 14. In illustrative embodiments, at least two pressure transducers or sensors are associated with each compressible bladder 32 to confirm and verify accuracy of measurements. In STEP 210, the temperature adjacent each thermal compression device and/or adjacent the extremity of the patient is monitored with the thermal sensors 18 and feedback is provided to the controller 14. Based on the feedback associated with STEPS 208 and 210 corrective action is automatically taken to address any undesired temperature readings or pressure readings. (STEP 212) In illustrative embodiments, the controller may automatically make adjustments. In other illustrative embodiments, the clinician makes the appropriate adjustments through the controller. It is also contemplated that both the clinician and the controller can act in concert and/or supplement control of the pressure and temperature, in STEP 214, the thermal compression treatment is continued or terminated. Treatment may be repeated as necessary. It is noted that the order of the STEPS in the flow chart 100 of FIG. 7 may be changed, altered or reversed or even combined, and that the method described herein in conjunction with FIG. 7 is not limited to the specific order and/or processes defined therein.

In illustrative embodiments the present invention provides the following features and advantages. The feedback control system via use of the temperature sensor 18 ensures that the temperature remains steady and does not overheat. The bladders fit snugly under the heating pads, and another feedback control system prevents the system from over pressurizing and injuring the patient. Heat and compression will be applied evenly across the extremities, and the device itself is lightweight and relatively compact. The design also makes the device easy to apply to the patient. In terms of the electrical design of the product, as there are up to possibly four separate heaters, which may be controlled by the controller one for each hand and foot, the device will be drawing a significant amount of current from the heating pads as well as the motors used to inflate the compression sleeves. This requires a PCB that can support up to 6 Amps of current at 24 Vdc. This can be supplied from mains AC voltage, using a wall wart power supply to convert the 120 AC to 24 Vdc. Each heating pad draws approximately 1 Amp at 24V. Based on the equation 1 where P is power, I is Current, and V is voltage.

P=I*V (1)

We can determine the heat output to be 24 Watts of thermal energy.

The active feedback sensors operate at much lower voltages and currents, and directly feed into the microcontroller. The Arduino Micro features twelve analog input pins, which is more than enough to measure the sensors listed below. The Micro also makes use of digital pins to control the MOSFETS and other transistors which act as switches for controlling the motors and other sections of the device. The sensor types may include:
4× ABPDANT005PGAA5 Pressure Sensor (Analog Voltage Output)
4× TMP36 Pressure Sensor (Analog Voltage Output)
4× PN2222ATF Transistors (Analog Voltage Input)
4× IRF510N MOSFETs (Digital Logic Input)

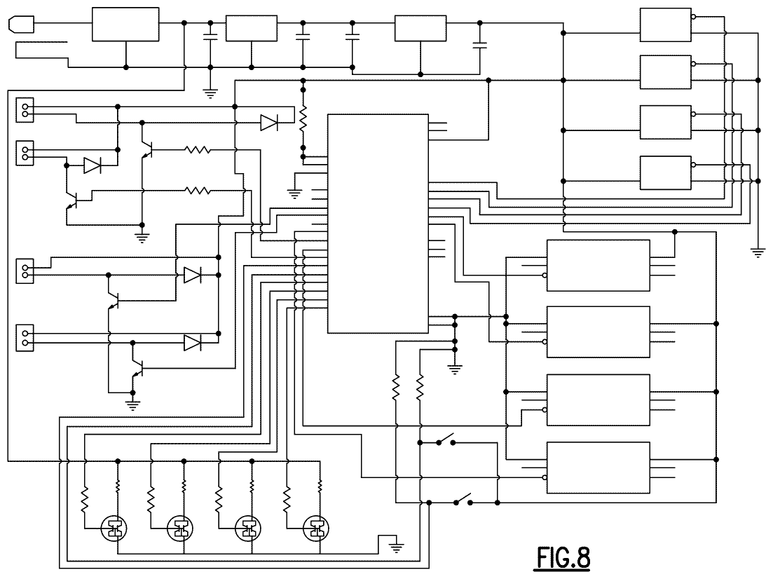

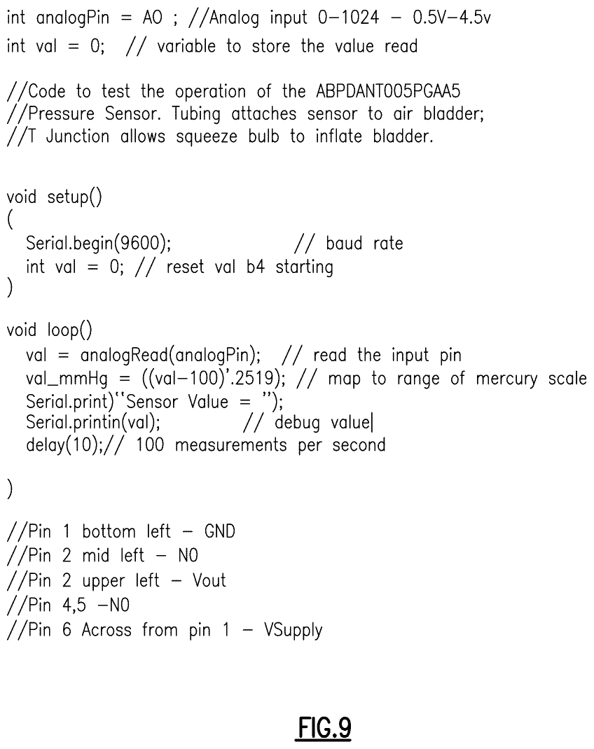

Trace widths on the board were designed to accommodate this amount, as well as using electronic components that can handle high currents, such as MOSFETs. The PCB may be designed in Altium Designer 21, with a 3D model as well as an electrical schematic for thorough documentation. FIG. 8 is a schematic further illustrating some of the electrical components of the system.

Redundant safety sensors may be implemented to provide an extra layer of security by comparing the two values and determining if they are both within a reasonable range of each other. The sensors selected and identified hereinabove may be well suited for medical applications and should withstand any sanitizing processes commonly found in hospitals.

The controller for the device (FIG. 6, for example) was made to fit all the electrical components while being comfortable to hold and easy to use. The design will also allow for the controller to be placed on the sides of hospital beds so it is not in the way of the patient and can be easily accessed by hospital personnel.

### Supporting Feasibility Evidence

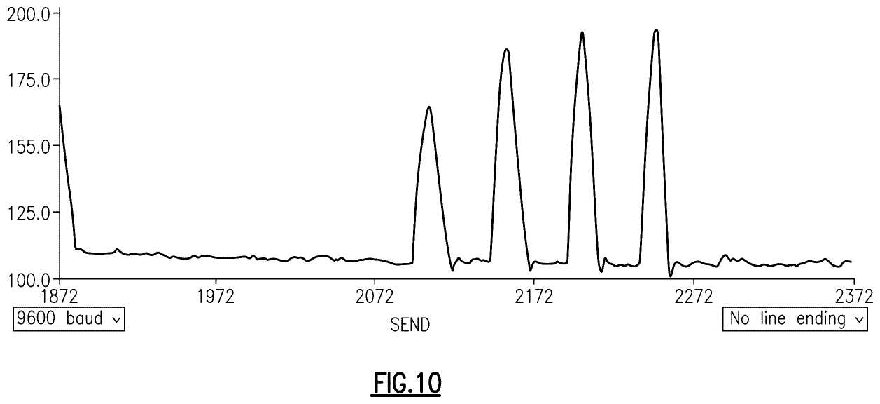

To verify the correct operation of sensors, a simple Arduino sketch was produced to verify the correct measurements and expected changes in output based on certain stimuli. As seen in the code snippet in FIG. 9 and the graph depicted in FIG. 10, the microcontroller will read an analog voltage from one of its pins, which is connected to the output of the pressure sensor being used for this project. It will then convert this reading (which is on a 290=1024 bit scale) from a voltage reading to the units of mm of mercury which is more commonly used in a medical context.

Although the illustrative embodiments of the present disclosure have been described herein with reference to the accompanying drawings, the above description, disclosure, and figures should not be construed as limiting, but merely as exemplifications of particular embodiments. It is to be understood, therefore, that the disclosure is not limited to those precise embodiments, and that various other changes and modifications may be effected therein by one skilled in the art without departing from the scope or spirit of the disclosure.

What is claimed is:

1. A system for thermal compression therapy, which comprises:
at least one thermal compression device for arranging relative to a limb of a patient, the at least one thermal compression device including:
one or more compression bladders, the one of more compression bladders configured to be selectively expandable in response to introduction of fluids therein; and
a thermal conductive member disposed about the one or more compression bladders, the thermal conductive member including a thermal conductive layer configured to distribute heat uniformly across an area of the limb of the patient.

2. The system according to claim 1 wherein the thermal conductive layer comprises a conductive carbon.

3. The system according to claim 1 including one or more pressure sensors and one or more temperature sensors.

4. The system according to claim 3 including a controller in communication with the one or more pressure sensors and the one or more temperature sensors.

5. The system according to claim 4 wherein:
the controller is configured to control flow of fluids into the one or more compression bladders in response to signals received from the one or more pressure sensors; and
the controller is configured to control temperature of the thermal conductive member in response to signals received from the one or more temperature sensors.

6. The system according to claim 4 including a plurality of thermal compression devices configured for arrangement around respective extremities of the patient.

7. The system according to claim 6 wherein the controller is configured to control operation of multiple thermal compression devices
